(19) United States
(12) Patent Application Publication
(10) Pub. No.: US 2016/0314440 A1
(43) Pub. Date: Oct. 27, 2016

(54) GUIDED VEHICLE REPAIR ESTIMATE SYSTEM AND METHOD

(71) Applicant: Audatex North America, Inc., San Diego, CA (US)

(72) Inventors: Frederic Bersot, Reno, NV (US); Charles G. Boyle, II, Hockessin, DE (US); Erin Noreen McIntosh, Higganum, CT (US); Michael T. Anderson, Bristol, RI (US)

(21) Appl. No.: 15/135,387

(22) Filed: Apr. 21, 2016

Related U.S. Application Data
(60) Provisional application No. 62/150,752, filed on Apr. 21, 2015.

(51) Int. Cl. G06Q 10/00; G06Q 40/08; G06F 3/0484; G06Q 30/02

(52) U.S. Cl. CPC G06Q 10/20; G06Q 30/0283; G06Q 40/08; G06F 3/04842

(57) ABSTRACT

A device and method that provides a predictive list of parts to be repaired for a damaged vehicle. The apparatus includes an interface that receives input regarding damage to the damaged vehicle, a predictive model that generates at least one part that is to be repaired from the input, and an output display that displays said at least one part that is to be repaired.

### CROSS-REFERENCE TO RELATED APPLICATION

This application claims the benefit of U.S. patent application No. 62/150,752.

### BACKGROUND OF THE INVENTION

1. Field of the Invention

The subject matter disclosed generally relates to a method and apparatus for providing a predictive list of parts that are repaired in a damaged vehicle.

2. Background Information

When a vehicle is damaged the owner will typically contact their insurance carrier and file a claim. The insurance carrier will have an adjuster, collision repairer, or other like personnel perform an estimate to determine the cost of repairing the vehicle. There are software products that assist the adjuster in preparing the estimate. Such products include graphical representations of the vehicle that allow the adjuster to select the damaged parts. These products require the adjuster to identify all of the parts that need to be repaired or replaced. This can be a time consuming process that is ripe for human error.

### BRIEF SUMMARY OF THE INVENTION

A device and method that provides a predictive list of parts to be repaired for a damaged vehicle. The apparatus includes an interface that receives input regarding damage to the damaged vehicle, a predictive model that generates at least one part that is to be repaired from the input, and an output display that displays the at least one part that is to be repaired.

### BRIEF DESCRIPTION OF THE DRAWINGS

FIG. 1 is a schematic of a system that can be used to generate a predictive list of parts that are to be repaired in a damaged vehicle;

FIG. 2 is a schematic of an exemplary client and/or server;

FIG. 3 is an illustration showing an exemplary input interface;

FIG. 4 is an illustration showing an exemplary display of predicted parts;

FIG. 5 is an illustration showing an exemplary display of related labor activity; and,

FIG. 6 is an illustration showing an exemplary graphical display of the predicted parts.

### DETAILED DESCRIPTION

Disclosed is a and method and apparatus that provides a predictive list of parts to be repaired for a damaged vehicle. The apparatus includes an interface that receives input regarding damage to the damaged vehicle, a predictive model that generates at least one part that is to be repaired from the input, and an output display that displays the at least one part that is to be repaired.

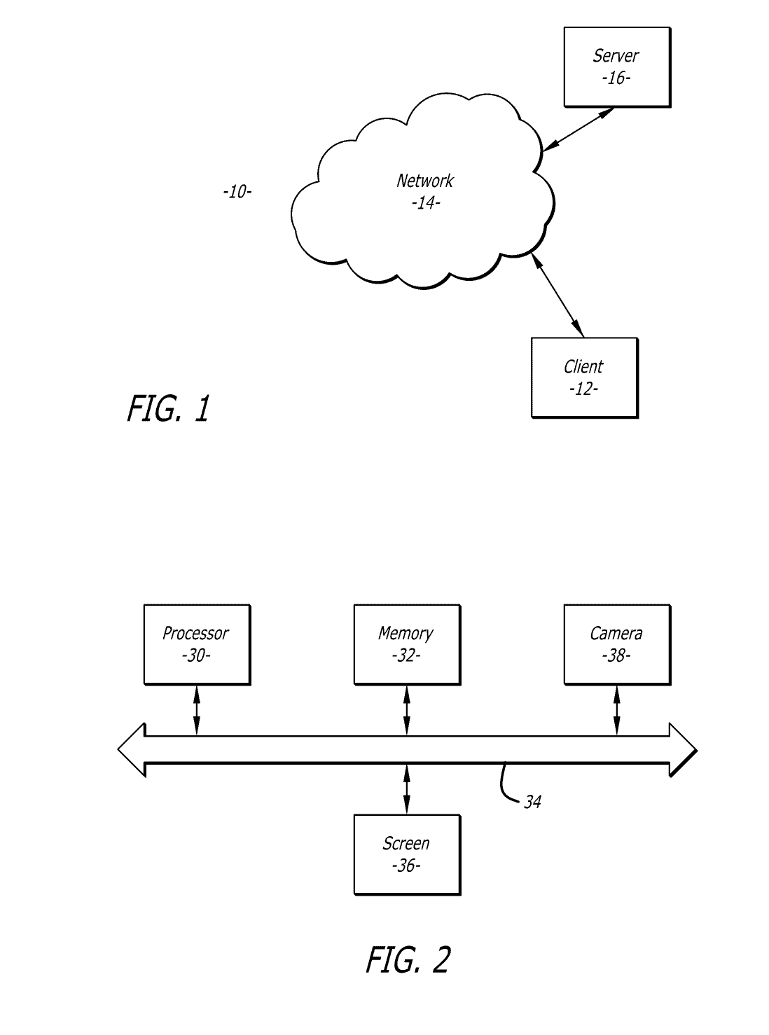

Referring to the drawings more particularly by reference numbers, FIG. 1 shows a system 10 that can be used to provide a predictive list of parts to repaired for a damaged vehicle. The system 10 may include at least one client 12 that is connected to an electronic communication network 14. The electronic communication network 14 may be a wide area network (WAN) such as the Internet. Accordingly, communication may be transmitted through the network 14 in TCP/IP format. The client 12 could be any type of device that can access the network 14, such as a computer or cellular phone.

The system 10 may further include a server 16 connected to the network 14. The server 16 includes databases and a predictive model that can generate various outputs including a predictive parts list for parts that are to be repaired in a damaged vehicle. Although one server 16 is shown, it is to be understood that the server 16 may include two or more separate servers.

FIG. 2 shows an exemplary embodiment of the client 12 and/or server 16. The client/server includes a processor 30 connected to one or more memory devices 32 through a bus 34. The memory device 32 may include both volatile and non-volatile memory such as read only memory (ROM) or random access memory (RAM). The processor 30 is capable of operating software programs in accordance with instructions and data stored within the memory device 32. Without limiting the scope of the invention the term computer readable medium may include the memory device 32. The computer readable medium may contain software programs in binary form that can be read and manipulated by the processor 30. The client/server may further include a screen 36 and include transceivers and network ports for communication through the network.

The server 16 may contain relational databases that correlate data with individual data fields and a relational database management system (RDBMS). The RDBMS of the server 16 may include a reference to a website that can be accessed by the client 12. The website has one or more specific uniform resource locators (URL) that can be used to access the site through the network 14. The URL can be entered through a web-based application resident in the client computer 12. By way of example, the web based application may be a browser.

The process to obtain a predictive list of parts to be repaired begins with input regarding the damaged vehicle. The input could be an interface that allows the user to mark the area of the vehicle that is damaged. This depiction can be either selecting a point of impact in the system, a photo of the vehicle or a 3-D graphical representation of the vehicle. This form of input can be the same or similar to the system described in U.S. application Ser. No. 14/513,027 which is hereby incorporated by reference. The input interface may also include a questionnaire to solicit input from the user.

FIG. 1 is an exemplary input interface showing graphical vehicle parts and selectable questions. The system may include a series of such interface screens with nested questions. For example, if the question “Do any of the doors open abnormally or cannot be opened?” is answered “Yes” a next screen(s) may be presented with question related to this issue.

The user input is sent to a predictive model that predicts the parts that would need to be replaced or repaired. The predictive model may also generate a cost estimate to repair the vehicle. The predictive model could be in the server and/or the client. The predictive model generates and transmits the predicted repair parts back for display to the user for selection or prefill of an estimate to repair the vehicle. The parts can be displayed with descriptive labels. For a group of parts, the main part(s) may be listed first.

FIG. 2 shows an exemplary display of predicted parts. The display interface may allow the user to indicate a repair, replace or other operation of the parts. The display may provide the user with a list of PXN suppliers and allow the user to select a specific supplier or part type. Likewise, the display may provide a list of recycled parts and allow the user to select a specific supplier or part type. The system may also display a list of related labor activity.

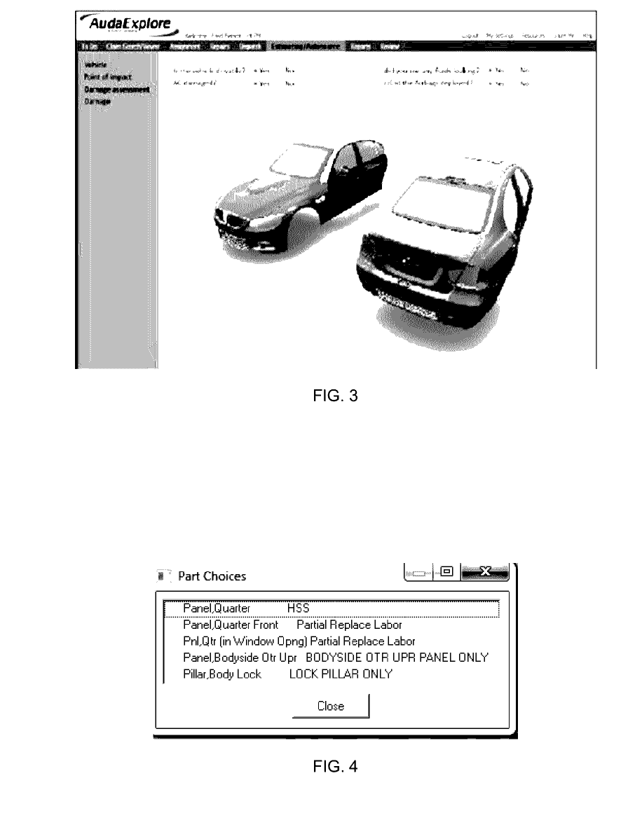

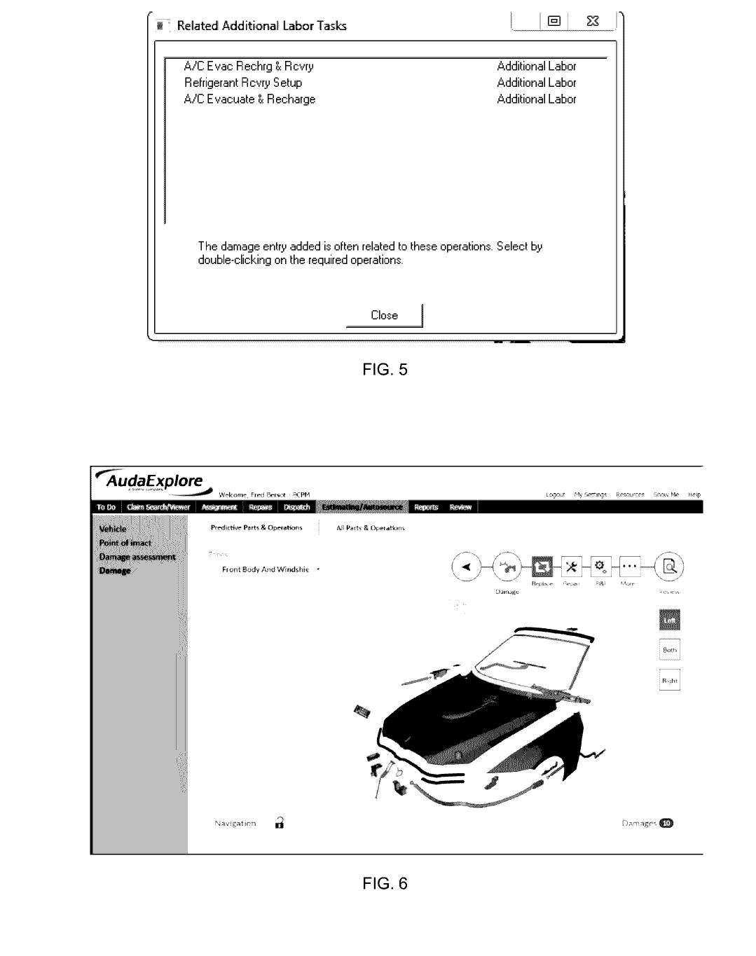

FIG. 3 is an exemplary display showing related labor activity for the air conditioning system of a vehicle. The system may allow the user to switch between the predictive parts lists and the cost estimate. For example, the predicted parts may be graphically displayed as shown in FIG. 4. The parts can be colorized when the user selects a part. The selected part can also be added to the cost estimate or prefill the estimate.

The system may also display, graphically, textually, etc., a list of parts that may be damaged and some type of indication regarding the probability of damage. For example, the system may graphically display a number of parts and colorize the parts in a manner that indicates the probability of damage to the part. Likewise, text such as “90%” can be provided to indicate a confidence level.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An apparatus that provides a predictive list of parts to be repaired for a damaged vehicle, comprising:
an interface that receives input regarding damage to the damaged vehicle;
a predictive model that generates at least one part that is to be repaired utilizing said input; and,
an output display that displays said at least one part that is to be repaired.

2. The apparatus of claim 1, wherein said input is an annotated image of the damaged vehicle.

3. The apparatus of claim 1, wherein said predictive model provides a cost estimate to repair the damaged vehicle.

4. The apparatus of claim 1, wherein said output display displays a list of suppliers for the at least one part that is to be repaired.

5. The apparatus of claim 1, wherein said predictive model provides a probability that the at least one part that is to be repaired is damaged.

6. A non-transitory computer program storage medium, comprising computer-readable instructions for providing a predictive list of parts to be repaired for a damaged vehicle, execution of said computer-readable instructions by at least one processor performs the steps:
receiving input on an interface regarding damage to the damaged vehicle;
generating at least one part that is to be repaired with a predictive model that utilizes said input; and,
displaying said at least one part that is to be repaired on an output display.

7. The non-transitory computer program storage medium of claim 6, wherein said input is an annotated image of the damaged vehicle.

8. The non-transitory computer program storage medium of claim 6, further comprising providing a cost estimate to repair the damaged vehicle.

9. The non-transitory computer program storage medium of claim 6, further comprising displaying a list of suppliers for the at least one part that is to be repaired.

10. The non-transitory computer program storage medium of claim 6, further comprising providing a probability that the at least one part that is to be repaired is damaged.

11. A method for providing a predictive list of parts to be repaired for a damaged vehicle, comprising:
receiving input on an interface regarding damage to the damaged vehicle;
generating at least one part that is to be repaired with a predictive model that utilizes the input; and,
displaying said at least one part that is to be repaired on an output display.

12. The method of claim 11, wherein said input is an annotated image of the damaged vehicle.

13. The method of claim 11, further comprising providing a cost estimate to repair the damaged vehicle.

14. The method of claim 11, further comprising displaying a list of suppliers for the at least one part that is to be repaired.

15. The method of claim 11, further comprising providing a probability that the at least one part that is to be repaired is damaged.
